(19) United States
(12) Patent Application Publication
(10) Pub. No.: US 2011/0101872 A1
(43) Pub. Date: May 5, 2011

(54) SYSTEMS AND METHODS FOR EMBEDDING INTERRUPTS INTO A SERIAL DATA STREAM

(75) Inventor: Robert Henig, Palo Alto, CA (US)

(73) Assignee: REDWOOD SYSTEMS, INC., Fremont, CA (US)

(21) Appl. No.: 12/609,695

(22) Filed: Oct. 30, 2009

(51) Int. Cl. G06F 13/24; H04L 1/18; G06F 11/14; H05B 37/02

(52) U.S. Cl. 315/152; 710/260; 714/749; 714/E11.113

(57) ABSTRACT

Systems and methods for transmitting and processing interrupts by embedding interrupt information into a serial data stream are disclosed. An event is detected and converted into an interrupt signal. The interrupt signal is converted into a special interrupt character or symbol sequence. The special interrupt character or symbol sequence is embedded into a serial data stream at the next available character or symbol boundary and transmitted to a receiving controller. The receiving controller strips the special interrupt character or symbol sequence from the serial data stream and raises a corresponding interrupt. The receiving controller processes the interrupt by interrupting normal processing to run an interrupt subroutine. Once the receiver has detected and raised an interrupt, it can return an acknowledgement character or symbol sequence by the same mechanism. The transmitter can repeat the interrupt embedding and transmission if it fails to receive the acknowledgement within a predetermined period of time.

### FIELD OF THE INVENTION

One or more embodiments of the present invention relate to implementing the functionality of interrupts without the use of dedicated lines for the interrupts.

### BACKGROUND

Lighting systems for areal illumination typically comprise (1) a set of “luminaires” (light fixtures comprising mounting hardware and one or more light-emitting elements such as incandescent or fluorescent bulbs or arrays of light-emitting diodes [LEDs]), together with (2) one or more sensor elements (motion sensors, light sensors, and the like), (3) control devices (such as dimmers and switches), and (4) power drivers to set the output light level of each luminaire as a function of sensor outputs and control device settings. Such systems can range in complexity from a single wall switch and bulb to commercial building lighting systems comprising hundreds of luminaires, sensors, and control devices. An example of such a lighting system for commercial building lighting is disclosed in co-owned and co-pending U.S. patent application Ser. No. 12/538,806 which is incorporated herein by reference.

Sensor devices such as motion sensors often sit quiescent for extended periods of time and change state only for brief periods of activity. Control systems may need to respond rapidly to these “events,” but it is undesirable for a control system to use resources to continually check for the occurrence of an event. For this reason, digital control systems that use such sensors often respond to these sensors via “interrupts.” That is, instead of continually polling the sensor to check for an event (and thereby wasting potentially valuable computational resources), the sensor device is configured to generate an “interrupt” signal, typically wired to a dedicated terminal on the controller. Only when an interrupt signal is received does the controller take any action with respect to the sensor (such as, for example, turning on one or more lights in response to detected motion). Typically, a specific interrupt response subroutine is run as soon as possible when the interrupt is received, interrupting any other data processing that may otherwise be in progress. Response to interrupts is often time-critical, and it can be important to respond as nearly as possible in “real time.” If there are multiple possible interrupts requiring response, an interrupt queue may be established, and interrupts are typically processed on a first-in-first-out basis from the interrupt queue, with normal data processing resuming when the queue is empty and all currently active interrupts have been processed.

Another example of a special activity embedded within normal processing can be found in the use of “escape sequences” or “control sequences.” These were first used in digital text communications devices where such escape sequences were used to embed non-printing functionality such as device control, font changes, or other mode changes into a character stream. Characters that were to be interpreted with a special meaning such as “change to italic font” were preceded and/or followed by a special character to indicate the special interpretation. The use of escape sequences was subsequently adopted in digital communications with all sorts of physical devices to embed special control functions and modal changes into normal data streams. Note that escape sequences are not interrupts. They implement mode changes that change the interpretation of particular characters in a character data stream, but they are not in any way event-driven. Escape character are inserted in an orderly fashion to indicate that, after processing one set of characters, a mode change should then be implemented to process the next set of characters. Interrupts, on the other hand, are used to process asynchronous events that can occur independently of “normal” data transmission and processing.

Another particular example of control sequences is the use of “XON/XOFF” for software control of data flow. When the receiving end of a data link is incapable of processing incoming data as fast as the transmitting end is capable of sending it, the receiving end sends “XOFF” to the transmitting end which then temporarily suspends data transmission until it is ready to accept data again, at which time the receiving end sends “XON” to indicate that it is again ready to accept data. For example, a computer may be able to send data to a serial printing device much faster than the device can format the data and output it to paper. The printing device may include a buffer to store data ahead, but even that buffer may have a finite capacity which can be exceeded when data is being transmitted faster than the buffer can be emptied. When the buffer is full, the printer transmits “XOFF” to indicate that it can no longer accept data; when there is again sufficient space in the buffer to store data, the printer transmits “XON,” and the source computer resumes transmission of data.

### SUMMARY OF THE INVENTION

Systems and methods for transmitting and processing interrupts by embedding interrupt information into a serial data stream are disclosed. An event is detected and converted into an interrupt signal. The interrupt signal is converted into a special interrupt character or symbol sequence. The special interrupt character or symbol sequence is embedded into a serial data stream at the next available character or symbol boundary and transmitted to a receiving controller. The receiving controller strips the special interrupt character or symbol sequence from the serial data stream and raises a corresponding interrupt. The receiving controller processes the interrupt by interrupting normal processing to run an interrupt subroutine. Once the receiver has detected and raised an interrupt, it can return an acknowledgement character or symbol sequence by the same mechanism. The transmitter can repeat the interrupt embedding and transmission if it fails to receive the acknowledgement within a predetermined period of time.

### DETAILED DESCRIPTION

Before the present invention is described in detail, it is to be understood that unless otherwise indicated this invention is not limited to specific sensor devices, electronic components, or the like, as such may vary. It is also to be understood that the terminology used herein is for the purpose of describing particular embodiments only and is not intended to limit the scope of the present invention.

It must be noted that as used herein and in the claims, the singular forms “a,” “and” and “the” include plural referents unless the context clearly dictates otherwise. Thus, for example, reference to “a fixture” includes two or more fixtures; reference to “a sensor” includes two or more sensors, and so forth.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

Embodiments of the present invention can be used with various supersets and subsets of the exemplary components described herein. For concreteness, embodiments of the invention will be described in the context of a commercial building illumination system comprising a set of LED luminaires, but the invention is not limited to the use of LEDs as light sources nor to use in building illumination systems. Any system that uses interrupts generated remotely from a control processor can make use of the present invention. Other exemplary systems include industrial controls, environmental controls, traffic control, water distribution systems, and the like. Interrupt signals can be generated by sensors of all sorts as well as timers and any other device that can generate an “event” at a particular time.

Embodiments of the present invention are directed to providing the equivalent of interrupt functionality using only an available serial communications channels to communicate the occurrence of an event from a remote sensor device to a controller. An exemplary implementation is provided using motion sensors that are part of a lighting system.

Generally, a “lighting system” according to one or more embodiments of the present invention comprises a set of “fixtures,” and at least one remote driver which collects information from a set of sensors and controls and sets the output light level for each light source (which may vary from zero to maximum—a non-zero light level that is limited by a maximum sustainable operating point for the light source). As used herein, a “fixture” can be a luminaire, or a standalone control or sensor; a “luminaire” is a light fixture including a light source plus suitable mounting hardware and decorative trim. In particular embodiments of the present invention, luminaires can further include light sensors designed to sense light from the light sources of adjacent luminaires (either via direct transmission or via reflection from the area under illumination) and additional signal sources and matching sensors using other wavelengths of light or other signal source/sensor technologies.

The lighting system further comprises communications means to allow each fixture to communicate with the control system. Such means can include direct wired connections, or any other known communications means such as optical fibers, wireless (radio frequency), ultrasonic, infrared, etc.

In certain embodiments, additional signal sources using various technologies such as radio frequency antennas; infrared, ultraviolet, or visible light sources; or ultrasonic emitters can also be provided. Such additional signal sources can provide means for measuring a variety of quantities useful for providing input to a lighting control system. Such quantities include motion, daylight, equipment-on status, presence of people, sound and noise, and the like. Sensors capable of receiving signals from the signal source(s) are also provided. For example, if the luminaire light source is the sole signal source provided, then an optical sensor such as a photodiode, phototransistor, or photoresistor built into the luminaire can be used as a suitable sensor. As another example, if an ultrasonic emitter is built into each luminaire, then an ultrasonic detector can be built into each luminaire to receive and detect the emitted ultrasonic signals. Further, each luminaire is associated with a microcontroller which serves as a luminaire controller. The microcontroller is capable of transmitting the output of sensors to a “remote driver” (described below). In certain embodiments, the microcontroller is also capable of controlling one or more of the installed signal sources, although typically it is not capable of directly controlling the power to the luminaire's main light source which is controlled instead by the remote driver. Microcontrollers can be dedicated to single luminaires or shared among two or more fixtures.

An example of a non-luminaire fixture in a lighting system is a fixture comprising a motion sensor, suitable control electronics, and a microcontroller capable of communicating with the remote driver.

In accordance with one or more embodiments of the present invention, the remote driver is connected to a set of fixtures including luminaires and sensors via serial communications channels such as wires, and no separate lines are available for communicating interrupt signals from sensors to the remote driver. The remote driver includes a controller that can manage communications with the set of fixtures and perform suitable control functions, for example, to set light levels according to algorithms based on sensor data, control settings, and time.

It is desirable for a control system to minimized the latency (time delay before action) of interrupt processing. It is therefore desirable to communicate the interrupt to the controller as nearly as possible in “real time,” and, in turn, it is desirable that the controller be cable to interrupt other activities to respond to the interrupt as quickly as possible. In accordance with one or more embodiments of the present invention, a fixture (such as a motion sensor assembly) that needs to transmit an interrupt signal to the controller transmits a specific predefined sequence of characters (an “escape sequence”) at the next possible character boundary. (A “character boundary” occurs after the end of transmission of each character. For example, if characters are encoded in bytes, then character boundaries correspond to byte boundaries.) Any suitable string of one or more characters may be used as the interrupt indicator as long as it can be uniquely distinguished from all other character strings that might be transmitted as data. For example, using 8-bit ASCII character encoding, 0x1B (hexadecimal 1B, equivalent to decimal 27) is commonly used as the “escape” character. If one further defines 0x18 as the “interrupt character,” then an interrupt escape sequence can be defined as the two characters, 0x1B 0x18. If there is no need to encode and process any other escape sequences besides the interrupt escape sequence, then a single-character interrupt escape sequence can be used.

Using the example of a motion sensor for a lighting system, a microcontroller associated with the motion sensor can be configured to routinely transmit, at regular intervals, status information (a device ID plus device health status, and sensor signal level, for example) as a character string. When the motion sensor electronics indicate that an interrupt is needed (because, for example, the sensor signal level crossed over a preset threshold value), the transmission of the character string is interrupted at the next character boundary, and the escape sequence is embedded into the character string.

In accordance with one or more embodiments of the present invention, at the receiving end, the controller monitors the received character string for interrupt escape sequences, strips them out of the character string in progress, and raises an interrupt. It can then take any appropriate action needed to respond to the interrupt event while continuing to place the rest of the character string in its input buffer for appropriate processing after the interrupt response action is complete. For example, if the interrupt event is motion detection, then “appropriate processing” may comprise turning on one or more light fixtures to a predetermined level.

In accordance with one or more embodiments of the present invention, the receiving controller also immediately returns an acknowledgement escape sequence to the sending device. If the sending device does not receive the acknowledgement sequence within a predetermined time interval (i.e., a time sufficient for the interrupt to be received and acknowledged), the interrupt is retransmitted. The acknowledgement escape sequence is similarly embedded as an interrupt escape sequence at the first available character boundary in the event that any character string is being transmitted to the sending device at the time. The microcontroller at the sending device monitors any received character string for escape sequences and strips them out, and raises an acknowledgement interrupt that is used to prevent retransmission of the original interrupt escape sequence.

The timing details and the length of the predetermined time interval depend on the bandwidth of the communications. This can be illustrated with the following example, whose specific numbers can be varied as appropriate for the bandwidth of particular serial communications protocols. Suppose the communications occur via a full-duplex 1 kbaud communications channel. Each bit takes 1 ms to transmit. Using 8-bit character encoding, and a two-character escape sequence, 16 bits are required to transmit an interrupt, and the minimum interrupt latency is 16 ms. Since the interrupt must be inserted on a byte boundary, an additional delay of up to a full byte or 8 ms could be needed to wait for the next byte boundary. In this example, it could take up to 24 ms for a generated interrupt to be encoded and transmitted to the controller. (Additional latencies in the hardware are likely to be much shorter than these communication delays.)

Once transmitted, the originator of the interrupt must wait an appropriate amount of time for an acknowledgment. Assuming full duplex communications at the same baud rate for both directions, the return path has the same latency as the path to the controller. Thus, the worst case latency for receiving an acknowledgement interrupt is also 24 ms as measured from the completion of the transmission of the original interrupt (plus any processing delays that must be accounted for).

When a motion sensor detects motion, the motion may continue for an extended period of time. If the sensor electronics are configured to generate an interrupt signal whenever motion is detected, then there is a need to limit the embedding of corresponding escape sequences so that the escape sequences do not clog the data transmission channel and overwhelm the controller with redundant interrupts. In accordance with one or more embodiments of the present invention, when a sensor device transmits an interrupt, it first waits for an acknowledgement, and if the acknowledgement is properly received within the predetermined time interval, it disables transmission of further escape sequences corresponding to new interrupts until the receiving controller sends a re-enablement signal via another escape sequence. This is conceptually similar to the XON/XOFF method of controlling data transmission described above in the Background section, but is newly applied in the instantly described invention to the control of the transmission of escape sequences representing interrupt events.

The time delay for the re-enablement interrupt can be set conveniently with respect to the need to respond to additional interrupts to fit particular applications. For example, for motion sensors in lighting systems, it can be convenient to consider the overall motion timeout. If a light or lights are to be program to turn off after ten minutes of no-motion detected in a workspace, then disabling motion interrupts for 10 sec yields a worst case error on the timeout of 10 sec, which would generally be acceptable. If motion is still ongoing, new motion interrupts would be generated only every 10 sec, thereby requiring minimal overhead to process the recurring interrupts.

In accordance with one or more embodiments of the present invention, the interrupt latency can be further reduced by encoding the interrupt as “symbols” rather than byte-length characters. In this embodiment, the bits of regular data are also encoded into “symbols.” For example and without limitation, if each regular data bit is encoded into a two-bit symbol, a regular data 1 can be encoded as a symbol 10, while a regular data 0 can be encoded as a symbol 01. Interrupts can then be inserted directly in the data stream at any point as long as they are represented by their own unique symbols. Depending on the communications protocol, various encodings are possible as illustrated by the following examples.

In accordance with one or more embodiments of the present invention, a synchronous serial communications channel is provided. The receiver always knows where symbol boundaries are, because the receiver clock is always synced with the transmitter clock. (Note that, in this context, the terms “transmitter” and “receiver” refer to the originator and detector of a particular datastream transmission. These may be either the sensor microprocessor or the controller processor in that communications can be bidirectional.) In this instance, interrupts can be inserted into the data stream at any symbol boundary by using a unique interrupt symbol or symbols. For example, the start of interrupt data could be indicated by the two-bit symbol 11. Interrupt data would follow, then a stop symbol 00 after which normal data transmission would resume. Alternatively, the symbols 11 and 00 could be used to represent interrupt data 1 and interrupt data 0 respectively. Since these symbols are unique (i.e., different from the data symbols 10 and 01, the interrupt data symbols and regular data symbols forming disjoint sets), they can always be uniquely distinguished from regular data, and interrupt data can be freely interleaved with regular data on symbol boundaries. The receiver simply diverts interrupt data into a separate buffer for separate processing.

In accordance with one or more embodiments of the present invention, longer symbols can also be used for interrupt data. For synchronous communications, with interrupt symbols always inserted on symbol boundaries, an even number of bits should be used, and symbols should be selected so that interrupt symbols can always be uniquely identified and separated from data symbols. For example, using four-bit interrupt symbols, one can use the symbols 0000, 0011, 1100, and 1111. These could be used to represent four different types of interrupts, or they could be used to encode interrupt data bits.

In accordance with one or more embodiments of the present invention, interrupt symbols are inserted on any bit boundary, either between symbols or within a symbol. In this case, interrupt symbols with an odd number of bits (typically three) can be advantageous. For example, interrupt data 1 can be represented by 111 and interrupt data 0 can be represented by 000. A stream of regular data encoded with the symbols 01 and 10 without interrupts always comprises strings of either one or two consecutive 1s or 0s. Thus a receiver can always extract any strings of three 1s or 0s and put appropriate bits into an interrupt data buffer.

In accordance with one or more embodiments of the present invention, an asynchronous serial data communications channel is provided. The data and interrupt symbol encoding methods described above can all be used, but there is a need to provide a mechanism to determine symbol boundaries for regular data. A “start” and/or “stop” symbol can be used to indicate the beginning and/or end of a packet of data. For example, a start symbol 1111 or 11111111 could be used. The receiver would not process any data until it received a start symbol which it could further use to establish the data transmission rate for that packet of data by timing the duration of the start symbol or measuring the time between bits in the start symbol. Once a packet of data is started, regular data and interrupt data can be freely interleaved on either bit or symbol boundaries according to the type of interrupt symbols used.

The use of symbol encoding of regular data slows the net transmission rate. For example, the use of two-bit symbols would double the number of bits that need to be transmitted for every packet of data. However, interrupt latency can be considerably reduced. Using the full-duplex 1 kbaud communications channel example discussed above, and an example system where interrupts comprising four bits (either one four-bit symbol, or two two-bit symbols) are inserted on two-bit symbol boundaries, the maximum latency for one-way interrupt transmission is reduced from 24 ms to 6 ms (4 ms for the interrupt symbol(s) plus up to 2 ms waiting for the next symbol boundary). For applications where the interrupt latency is more important that the regular data transmission rate, this can be a good tradeoff to make.

It will be understood that the descriptions of one or more embodiments of the present invention do not limit the various alternative, modified and equivalent embodiments which may be included within the spirit and scope of the present invention as defined by the appended claims. Furthermore, in the detailed description above, numerous specific details are set forth to provide an understanding of various embodiments of the present invention. However, one or more embodiments of the present invention may be practiced without these specific details. In other instances, well known methods, procedures, and components have not been described in detail so as not to unnecessarily obscure aspects of the present embodiments.

What is claimed is:

1. A method of transmitting and processing interrupts comprising
detecting an event and generating an interrupt signal corresponding to said event,
converting said interrupt signal into a special interrupt character sequence,
embedding said special interrupt character sequence into a serial data stream transmitted from a transmitting device to a receiving controller at the next available character boundary,
stripping said special interrupt character sequence from said serial data stream at said receiving controller,
raising a second interrupt in said receiving controller corresponding to said special interrupt character sequence, and
processing said second interrupt by interrupting normal processing to run an interrupt subroutine,
wherein said event is unrelated to the process of transmitting said serial data stream.

2. The method of claim 1, further comprising
embedding a special acknowledgment character sequence into a return serial data stream from said receiving controller to said transmitting device at the next available character boundary,
stripping said special acknowledgement character sequence from said return serial data stream at said transmitting device, and
re-embedding and retransmitting said special interrupt character sequence if said special acknowledgement character sequence is not received within a predetermined period of time.

3. The method of claim 2, further comprising
disabling transmission of additional special interrupt character sequences if said special acknowledgement character sequence is received within said predetermined period of time,
embedding a special re-enable character sequence into a return serial data stream from said receiving controller to said transmitting device,
stripping said special re-enable character sequence from said return serial data stream at said transmitting device, and
re-enabling transmission of additional special interrupt character sequences.

4. The method of claim 1, wherein said transmitting device and said receiving controller are components of a lighting system for areal illumination comprising said receiving controller and a plurality of fixtures comprising luminaires, optional control devices, and at least one standalone sensors, one of which comprises said transmitting device;
wherein each of said luminaires comprises a light source whose output light level can be adjusted, a light sensor co-located therewith adapted to measure light received from adjacent fixtures, and a microcontroller capable of transmitting the output of said light sensor over wires to said receiving controller; and
wherein said receiving controller is capable of bidirectional communication with said luminaires and providing independently controllable power for the light sources of said luminaires such that the output light level of each of said light sources can vary from zero to a maximum.

5. A method of transmitting and processing regular data and interrupt data comprising
detecting an event and generating an interrupt signal corresponding to said event,
encoding each bit of regular data into regular data symbols of two or more bits,
encoding each bit of interrupt data into interrupt data symbols of two or more bits wherein said regular data symbols and said interrupt data symbols form disjoint sets,
embedding encoded interrupt data into a serial data stream of encoded regular data transmitted from a transmitting device to a receiving device at the next available symbol boundary,
stripping said encoded interrupt data from said serial data stream at said receiving controller,
raising an interrupt in said receiving controller corresponding to said instance of encoded interrupt data, and
processing said interrupt by interrupting normal processing to run an interrupt subroutine.

6. The method of claim 5, wherein said regular data symbols comprise two bits.

7. The method of claim 5, wherein said interrupt data symbols comprise two bits.

8. The method of claim 5, wherein said interrupt data symbols comprise three bits.

9. The method of claim 5, wherein said interrupt data symbols comprise four bits.

10. A system for rapid response to events comprising
a signal source capable of generating an event unrelated to the process of transmitting a serial data stream,
electronic circuitry capable of detecting said event and generating an interrupt signal,
a first digital processor capable of receiving said interrupt signal and converting said interrupt signal into a special interrupt character sequence,
a serial data connection from said first digital processor to a second digital processor,
wherein said interrupt character sequence is embedded into the serial data stream transmitted from said first digital processor to said second digital processor at the next available character boundary, said special interrupt character sequence is stripped from said serial data stream at said second digital processor, a second interrupt is raised in said second digital processor corresponding to said special interrupt character sequence, and wherein normal processing in said second digital processor is interrupted to run an interrupt subroutine.

11. The system of claim 10, further comprising a lighting system for areal illumination comprising
a plurality of fixtures comprising luminaires, optional control devices, and at least one standalone sensors, one of which comprises signal source and said first digital processor;
wherein each of said luminaires comprises a light source whose output light level can be adjusted, a light sensor co-located therewith adapted to measure light received from adjacent fixtures, and a microcontroller capable of transmitting the output of said light sensor over wires to said second digital processor; and
wherein said second digital processor is capable of bidirectional communication with said luminaires and providing independently controllable power for the light sources of said luminaires such that the output light level of each of said light sources can vary from zero to a maximum.
